(19) United States
(12) Patent Application Publication
(10) Pub. No.: US 2008/0006436 A1
(43) Pub. Date: Jan. 10, 2008

(54) ELECTRIC WIRE

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/681,198

(22) Filed: Mar. 2, 2007

(30) Foreign Application Priority Data
Jul. 7, 2006 (CN) 200610061557.1

(51) Int. Cl. H01B 7/08

(52) U.S. Cl. 174/117 F

(57) ABSTRACT

An electric wire assembly includes at least two electric wires. Each of the at least two electric wires includes an insulating sheath. A protrusion having a certain length is formed longitudinally on an outer surface of the insulating sheath of one of the at least two electric wires. A recess having a certain length is defined longitudinally in the outer surface of the insulating sheath of another one of the at least two electric wires. The protrusion is configured for engaging in the recess thereby binding the at least two electric wires together.

### BACKGROUND OF THE INVENTION

1. Field of the Invention

The present invention relates to an electric wire, and an assembly of a plurality of bound electric wires.

2. Description of related art

There are a large number of electric wires in an electronic device such as a computer to connect electronic components thereof. The electric wires can create a messy environment inside the computer, and reduce heat-dissipation efficiency. A typical electric wire includes a conductive core, and an insulating sheath surrounding the conductive core. The insulating sheath has a smooth outer surface. To tidy up the electric wires, extra fixing members such as wire binders, wire-clamping fixtures etc., are utilized. The extra fixing members increase cost of the computer.

What is needed is an electric wire which can be easily bound with other electric wires.

### SUMMARY OF THE INVENTION

An exemplary electric wire assembly includes at least two electric wires. Each of the at least two electric wires includes an insulating sheath. A protrusion having a certain length is formed longitudinally on an outer surface of the insulating sheath of one of the at least two electric wires. A recess having a certain length is defined longitudinally in the outer surface of the insulating sheath of another one of the at least two electric wires. The protrusion is configured for engaging in the recess thereby binding the at least two electric wires together.

Other advantages and novel features will become more apparent from the following detailed description when taken in conjunction with the accompanying drawings, in which:

### BRIEF DESCRIPTION OF THE DRAWINGS

FIG. 1 is an isometric view of a set of electric wires which are bound together in accordance with a preferred embodiment of the present invention;

FIG. 2 is an enlarged view of a circled portion II of FIG. 1;

FIG. 3 is a cross-sectional view taken along line III-III of FIG. 1;

FIG. 4 is a cross-sectional view taken along line IV-IV of FIG. 1; and

FIG. 5 is a cross-sectional view of two rows of the electric wires of FIG. 1 bound together.

### DETAILED DESCRIPTION OF THE INVENTION

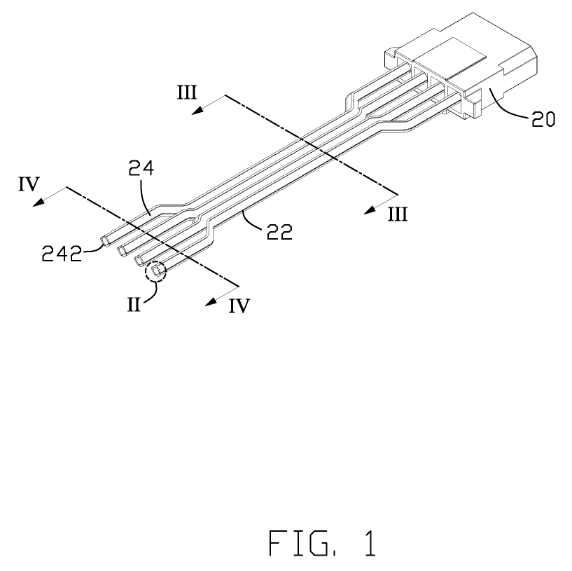

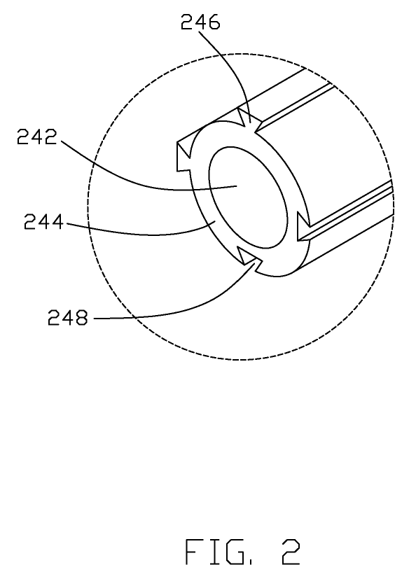

Referring to FIG. 1, a set of electric wires 24 in accordance with a preferred embodiment of the present invention is connected to a connector 20. Referring also to FIG. 2, each electric wire 24 includes a conductive core 242, and an insulating sheath 244 surrounding the conductive core 242. Two longitudinal protrusions 246 are formed on an outer surface of the insulating sheath 244, and two longitudinal recesses 248 are defined in the outer surface of the insulating sheath 244. Preferably, the protrusions 246 each have a dovetail cross-section, and the recesses 248 each have a dovetail cross-section, which is substantially complementary to that of each protrusion 246. Preferably, the two protrusions 246 and the two recesses 248 are evenly arranged at the outer surface of the insulating sheath 244. The two protrusions 246 are neighboring each other, and the two recesses 248 are neighboring each other.

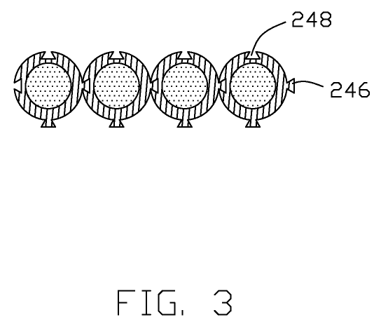

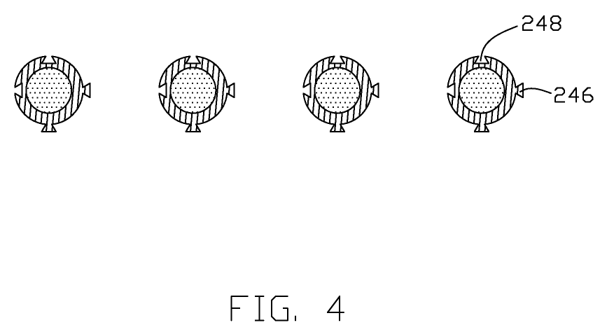

The insulating sheath 244 of each electric wire 24 adopts flexible material. Referring also to FIG. 3, one of the protrusions 246 of the insulating sheath 244 of one electric wire 24 is urged into one of the recesses 248 of the insulating sheath 244 of a neighboring electric wire 24. Thereby, the set of electric wires 24 are easily bound together. Referring also to FIG. 4, ends of the electric wire 24 opposing the connector 20 are separated from each other for connecting with electric components.

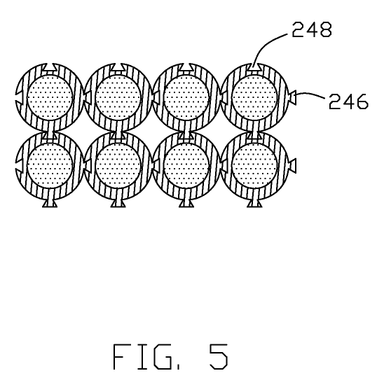

Referring also to FIG. 5, two sets of the electric wires 24 are bound together. The number of the protrusions 244 and the recesses 246 of each electric wire 24 can be arranged according to need. The length of the protrusions 244 and the recesses 246 can be arranged according to need.

The foregoing description of the exemplary embodiment of the invention has been presented only for the purposes of illustration and description and is not intended to be exhaustive or to limit the invention to the precise forms disclosed. Many modifications and variations are possible in light of the above teaching. The embodiment was chosen and described in order to explain the principles of the invention and its practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. An electric wire assembly comprising at least two electric wires, each of the at least two electric wires comprising an insulating sheath, wherein a protrusion having a certain length is formed longitudinally on an outer surface of the insulating sheath of one of the at least two electric wires, a recess having a certain length is defined longitudinally in the outer surface of the insulating sheath of another one of the at least two electric wires, the protrusion is configured for engaging in the recess thereby binding the at least two electric wires together.

2. The electric wire assembly as claimed in claim 1, wherein the protrusion has a dovetail cross-section, and the recess has a dovetail cross-section, which is complementary to that of the protrusion.

3. The electric wire assembly as claimed in claim 1, wherein the insulating sheath is made of flexible material.

4. The electric wire assembly as claimed in claim 1, wherein the insulating sheath has two protrusions and two recesses evenly arranged at the outer surface thereof.

5. An electric wire comprising an insulating sheath, wherein at least one longitudinal protrusion and at least one longitudinal recess are arranged at an outer surface of the insulating sheath, the at least one protrusion is configured for engaging in a recess of an insulating sheath of another electric wire thereby binding the two electric wires together.

6. The electric wire as claimed in claim 5, wherein the at least one protrusion has a dovetail cross-section, and the at least one recess has a dovetail cross-section which is complementary to that of the at least one protrusion.

7. The electric wire as claimed in claim 5, wherein the insulating sheath is made of flexible material.

8. The electric wire as claimed in claim 5, wherein the at least one longitudinal protrusion comprises two protrusions, and the at least one longitudinal recess comprises two recesses, the two protrusions and the two recesses are evenly arranged at the outer surface of the insulating sheath.

9. An electric wire assembly comprising:
a connector; and
at least two electric wires ends of which are spaced from each other and connected to the connector, each of the at least two electric wires comprising a conductive core and an insulating sheath surrounding the conductive core, a recess being defined longitudinally in the outer surface of the insulating sheath of one of the at least two electric wires, a protrusion with a shape complementary to that of the recess being formed longitudinally on an outer surface of the insulating sheath of another one of the at least two electric wires and attachably received in the recess thereby binding the at least two electric wires together.

10. The electric wire assembly as claimed in claim 9, wherein the insulating sheaths are made of flexible material such that the protrusion can be easily urged into the recess.

11. The electric wire assembly as claimed in claim 9, wherein the protrusion has a dovetail cross-section, and the recess has a dovetail cross-section complementary to that of the protrusion.

12. The electric wire assembly as claimed in claim 9, further comprising at least another one electric wire which is binded to one of said at least two electric wires via another protrusion being attachably received in another recess respectively defined in said at least another one electric wire and said one of the at least two electric wires, said at least another one electric wire being not aligned with said at least two electric wires.
